(19) United States
(12) Patent Application Publication
(10) Pub. No.: US 2007/0098969 A1
(43) Pub. Date: May 3, 2007

(54) Light-guiding assembly and automotive vehicle roof

(75) Inventors: Johannes Petrus Maria Ansems, Eindhoven (NL); Augustinus Gregorius Henricus Meijers, Eindhoven (NL); Helmut Maeuser, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/596,079

(22) PCT Filed: Nov. 18, 2004
(86) PCT No.: PCT/IB04/52480

§ 371 Date: May 30, 2006

(30) Foreign Application Priority Data
Dec. 2, 2003 (EP) 03104489.4

(51) Int. Cl. B32B 17/06; B32B 7/02

(52) U.S. Cl. 428/212; 428/426

(57) ABSTRACT

A light-guiding assembly for vehicle roofs has a plurality of glass sheets (1, 2) with an interlayer (3) of a polymeric laminating material interposed. The light-guiding assembly has light-coupling means (5) for coupling light into the light-guiding assembly. According to the invention, the light coupled into the interlayer (3) is substantially guided through the interlayer (3). Preferably, the refractive index of the interlayer is higher than the refractive index of the glass sheets. Preferably, refractive layers (8, 9) of a material with a refractive index lower than the refractive index of the interlayer (3) are provided adjacent the interlayer between the respective glass sheets (1, 2) and the interlayer (3). Preferably, the light-guiding assembly is provided with a recess (10), the recess (10) being adapted to receive the light-coupling means (5).

The invention relates to a light-guiding assembly for vehicle roofs comprising a plurality of glass sheets and an interlayer of a polymeric laminating material.

The invention also relates to an automotive vehicle roof provided with such a light-guiding assembly.

Automotive manufacturers are developing models having increasingly large glazed surface areas. The dimensions of windscreens and rear screens are increasing particularly to improve aerodynamic profiles. In addition, glazing is becoming preponderant in the manufacture of sunroofs. Following this tendency, motor vehicles are equipped with increasingly large sliding glass sunroofs or panoramic glass roofs in spite of drawbacks regarding air conditioning engineering, such as overheating of the vehicle cabin owing to insulation. The reason for nevertheless providing such roofs is the spacious and friendly room atmosphere resulting for the passengers in a bright, light-flooded passenger compartment. Conventional closed roof linings illuminate the passenger compartment only indirectly by the stray light incident into the passenger compartment through the side windows. The strong contrast against the bright surroundings cause the conventional roof linings to appear relatively dark and possibly to have an oppressive effect on the driver.

The light-guiding assembly can be used in vehicles with a transparent vehicle roof, for example a so-called sunroof, or in vehicles with a non-transparent roof, for instance provided with a normal roof lining, in which case the light-guiding assembly is arranged adjacent the vehicle roof.

A light-guiding assembly is known from US-A 2002/0 167 820. The known light-guiding assembly comprises a light-generating unit which can be switched on and off electrically and a optical waveguide which is used for guiding the light and which is coupled to the light-generating unit for coupling in the light. In the known light-guiding assembly, the optical waveguide is arranged in the area of the interior lining of the vehicle roof and designed as a flat optical waveguide, the light being coupled in at one or more lateral surfaces of the optical waveguide. In addition, the flat optical waveguide is prepared such that the light couples out of the optical waveguide into the passenger compartment of the vehicle over a large surface area and in a homogeneous manner. The known light-guiding assembly improves the lighting conditions of the passenger compartment of a motor vehicle. A disadvantage of the known light-guiding assembly is that the light emitted by the glass assembly has a greenish color.

The invention has for its object to provide a light-guiding assembly wherein said drawback is obviated. According to the invention, a light-guiding assembly of the kind mentioned in the opening paragraph for this purpose comprises:
a plurality of glass sheets,
an interlayer of a polymeric laminating material interposed between the glass sheets,
light-coupling means for coupling light into the light-guiding assembly,
the light coupled into the interlayer being guided substantially through the interlayer.

When light travels through a sheet of glass over a substantial distance (typically more than a few centimeters) and is subsequently coupled out from the glass sheet, the emitted light has a greenish color. This greenish color is caused by absorption and/or selective scattering in the glass. Such a greenish color can be avoided with the use of very special types of glass. Such special types of glass are relatively expensive, which renders them less suitable for use in automotive vehicles. The light-guiding assembly according to the invention has been adapted to provide that light coupled into the light-guiding assembly is substantially guided through the interlayer, thus avoiding that the light also travels through the glass sheets. The emission of greenish light by the light-guiding assembly is thus largely avoided. In addition, effects of rain drops on the glass sheets or scratches or dust present on the glass sheets do not influence the uniformity of the light coupled out from the light-guiding assembly because the light does not pass through the glass sheets.

In the known light-guiding assembly, the material of the interlayer has been selected such that the refractive index of the interlayer is substantially the same as that of the glass sheets. Well-known materials for the interlayer are polyvinyl butyral (PVB) and ethylene-vinyl acetate (EVA). Light which is coupled into the known light-guiding assembly is not reflected at either of the two glass/interlayer interfaces because the refractive index of the interlayer material is so close to that of glass. As a consequence, the light in the light-guiding assembly travels through the glass sheets as well as through the interlayer. When such light is eventually coupled out from the light-guiding assembly, it will be greenish due to the absorption effects in the glass sheets.

The measure according to the invention provides that light pasage in the light-guiding assembly substantially takes place in the interlayer, while the chance that light will travel through the glass sheets is reduced. In the light-guiding assembly according to the invention, the principle of total internal reflection is used at the interfaces between the interlayer and the glass sheets. In this manner, the interlayer in the light-guiding assembly according to the invention is used as the principal optical waveguide.

There are several embodiments for realizing total internal reflection at the interfaces between the interlayer and the glass sheets. To this end, a preferred embodiment of the light-guiding assembly in accordance with the invention is characterized in that the refractive index of the interlayer is higher than the refractive index of the glass sheets. Due to the differences in refractive indexes between the glass sheet and the interlayer, the light traveling through the light-guiding assembly is guided substantially through the interlayer. The refractive index of the material of the interlayer has to be chosen such that no light traveling through the interlayer is coupled into the glass sheets adjacent the interlayer. To this end, a preferred embodiment of the light-guiding assembly in accordance with the invention is characterized in that the refractive index of the interlayer is higher than 1.57. The larger the difference in refractive indices between the interlayer and the glass sheets, the larger the numerical aperture of the coupling of light into the light-guiding assembly. A suitable material for such an interlayer is a polycarbonate (refractive index approximately 1.59).

Another method for realizing total internal reflection at the interfaces between the interlayer and the glass sheets is by inserting a refractive layer at the interfaces between the interlayer and the glass sheet. To this end, a preferred embodiment of the light-guiding assembly in accordance with the invention is characterized in that a refractive layer of a material with a refractive index lower than the refractive index of the interlayer is provided between each glass sheet and the interlayer, adjacent the interlayer. The refractive layer provides that the light has a preference for traveling in the interlayer, and the coupling-out of light from the interlayer into the glass sheet is avoided. The refractive index of the material of the refractive layer has to be chosen such that no light traveling through the interlayer is coupled into the glass sheets. To this end, a preferred embodiment of the light-guiding assembly in accordance with the invention is characterized in that the refractive index of the refractive layer is lower than 1.50. Suitable materials for such a refractive layer are polymethyl methacrylate, magnesium fluoride, and teflon.

A favorable embodiment of the light-guiding assembly in accordance with the invention is characterized in that the light-coupling means are adapted to couple the majority of the light into the interlayer. Such a provision favors the traveling of the light through the interlayer and largely avoids that the light coupled into the light-guiding assembly travels through the glass sheets. Preferably, the light-guiding assembly is provided with a recess, the recess being adapted to receive the light-coupling means.

These and other aspects of the invention will be apparent from and elucidated with reference to the embodiment(s) described hereinafter.

In the drawings:

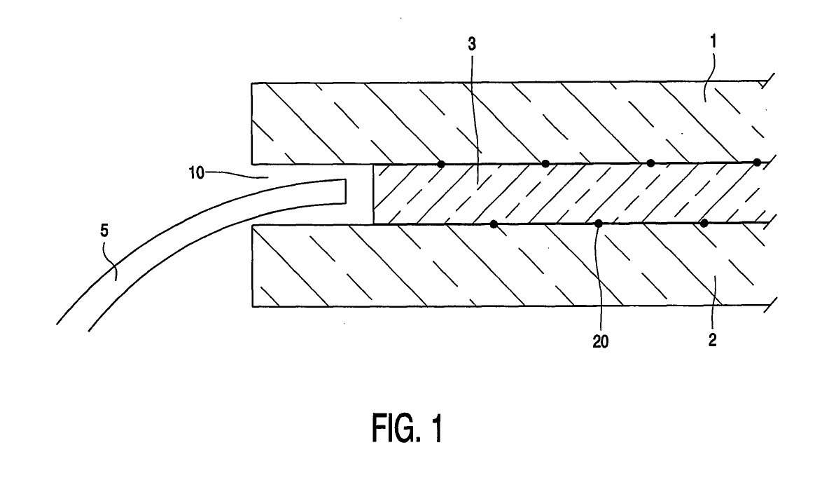

FIG. 1 is a cross-sectional view of an embodiment of the light-guiding assembly for vehicle roofs according to the invention, and

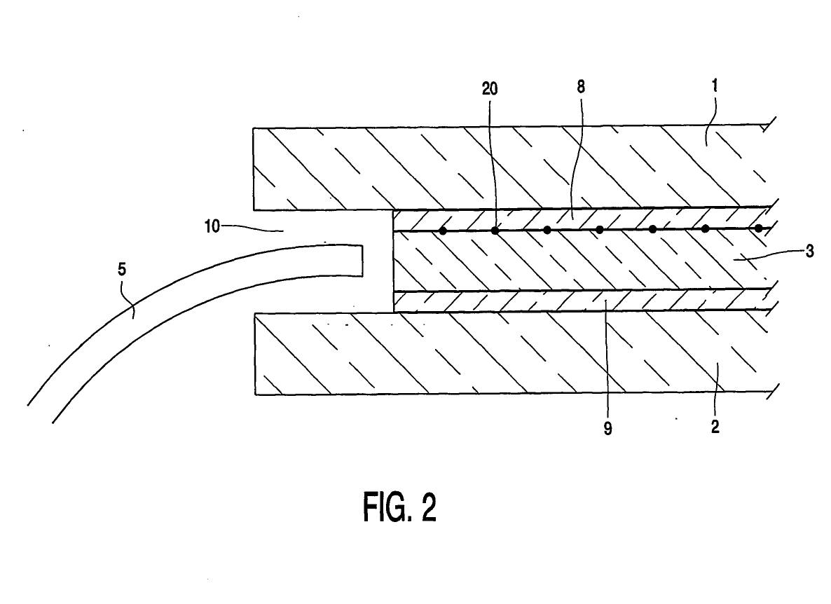

FIG. 2 is a cross-sectional view of an alternative embodiment of the light-guiding assembly for vehicle roofs according to the invention.

The Figures are purely schematic and not drawn to scale. Particularly for clarity, some dimensions are exaggerated strongly. In the Figures, like reference numerals refer to like parts whenever possible.

FIG. 1 is a cross-sectional view of an embodiment of the light-guiding assembly according to the invention. Such a light-guiding assembly improves the lighting conditions in the passenger compartment of a motor vehicle. The light-guiding assembly is preferably arranged in the area of the interior lining of the vehicle roof and is preferably designed as a flat optical waveguide. The light-guiding assembly is prepared such that the light is coupled out from the light-guiding assembly into the passenger compartment of the vehicle over a large surface area and in a homogeneous manner. Unlike conventional light sources such as incandescent lamps, the light-guiding assembly according to the present invention does not serve as a discrete lighting element but produces a large-surface and glare-free brightening of the roof lining in the overhead area of the vehicle occupants. The light-guiding assembly produces an apparent enlargement of the passenger compartment, creating a pleasant room atmosphere. The advantage of this is that the homogeneous brightening of the passenger compartment has a positive psycho-physiological effect on the vehicle occupants. This positive effect on the vehicle occupants is achieved in particular in the dark, for example when driving in tunnels or at night. The light-guiding assembly according to the present invention achieves a glare-free brightening of the passenger compartment in darkness, as a result of which the orientation of the vehicle occupants is improved. In addition, the pleasant room atmosphere created by the luminous roof promotes an attentive and stress-free driving in the dark. A further advantage of the light-guiding assembly is that it can be used as a component of the overall vehicle, in particular as a design element in the passenger compartment of the vehicle.

In the embodiment of FIG. 1, the light-guiding assembly comprises two glass sheets 1, 2. The glass sheets 1, 2 are made of normal window glass (refractive index 1.54). In an alternative embodiment, the sheets are made of, for instance, polymethyl methacrylate (PMMA), polycarbonate (PC), or someother suitable material. In an alternative embodiment, one of the glass sheets (preferably on a side facing the exterior of the vehicle) is made of a light-absorbing material, for example for reducing the heat input from sunlight. The sheets are translucent to visible light. In addition, one of the sheets may be colored and/or may comprise means for reducing heat input from outside the vehicle and/or to reduce loss of heat from the vehicle to the exterior. Between the glass sheets 1, 2 an interlayer 3 of a polymeric laminating material is interposed. Light-coupling means 5 are provided for coupling light into the light-guiding assembly. In the embodiment of FIG. 1, the light-coupling means 5 comprise an optical fiber emitting light from a remote light source. The optical fiber is coupled to a light-generating unit (not shown in FIG. 1) which can be switched on and off electrically. Suitable light-generating units are formed by one or more fluorescent tubes, lighting cords, or light-emitting diodes. Such light sources have a small overall depth, permitting a space-saving installation into the vehicle. For example, the light-generating units may be placed in the lateral side rails of the vehicle. Preferably, an electrical control loop (not shown in FIG. 1) is provided, including a brightness sensor for adapting the luminous intensity which is radiated into the passenger compartment of the vehicle to the ambient brightness.

According to the invention, light coupled into the interlayer 3 substantially propagates through the interlayer 3 by means of total internal reflection. In the embodiment of the invention shown in FIG. 1, this is realized in that the refractive index of the interlayer 3 is higher than the refractive index of the glass sheets 1, 2. In this manner, the light coupled into the light-guiding assembly preferably travels through the interlayer, and the propagation of light through the glass sheets is largely avoided. The refractive index of the material of the interlayer has to be chosen such that no light traveling through the interlayer is coupled into the glass sheets adjacent the interlayer. To this end, a preferred embodiment of the light-guiding assembly in accordance with the invention is characterized in that the refractive index of the interlayer 3 is higher than the refractive index of the glass sheets 1, 2. Preferably, the refractive index of the interlayer 3 is higher than 1.57. A suitable interlayer material is a polycarbonate (PC; refractive index approximately 1.59).

Preferably, the light-coupling means 5 are adapted to couple the majority of the light into the interlayer 3. In the example of FIG. 1, the light-guiding assembly is provided with a recess 10. The recess 10 is adapted to receive the light-coupling means. Such a recess 10 provides that the majority of the light is coupled into the interlayer 3. In an alternative embodiment, the light source is directly provided in the recess 10.

The range, the color, and the intensity of the light conveyed in the light-guiding assembly are determined by the aspect ratio, i.e. the ratio of the length to the thickness or the diameter of the optical waveguide. Preferably, the thickness of the glass sheets 1,2 is approximately 2.1 mm and the thickness of the interlayer 3 is approximately 1.52 mm.

To couple out the light from the light-guiding assembly, so-called scattering centers 20 are introduced into the light-guiding assembly for coupling out the light which is guided in the light-guiding assembly. In an alternative embodiment, the scattering centers are provided at one side of the interlayer only, thereby confining the coupling-out of light to one direction only. Since the light has a preference for propagating through the interlayer, according to the invention, the scattering centers 20 are preferably applied at the boundary surfaces of the interlayer 3. Such scattering centers 20 are preferably highly refractive pigments such as white paint, titanium oxide, or air inclusions having a particle size greater than the wavelength of (visible) light. The discontinuity at the scattering centers 20 causes the light guided in the interlayer 3 to be deflected at these scattering centers. The scattering centers 20 may also be advantageously designed as fibers or colored particles. In addition, the scattering centers may be particles having a particle size below the wavelength of visible light. In this case, the deflection of the light is determined by Rayleigh scattering with an isotropic scattering angle distribution. Part of the scattered light directly enters the passenger compartment of the vehicle. The portion of light which is scattered in the direction of the vehicle roof is preferably reflected back into the light-guiding assembly via a reflecting cover arranged between the vehicle roof and the light-guiding assembly. Alternatively, the interior lining of the vehicle roof may exhibit reflective properties.

FIG. 2 is a cross-sectional view of an alternative embodiment of the light-guiding assembly according to the invention comprising two translucent glass sheets 1, 2. An interlayer 3 of a polymeric laminating material is interposed between the glass sheets 1, 2. Light-coupling means 5 for coupling light into the light-guiding assembly are provided. In the embodiment of FIG. 2, two refractive layers 8; 9 of a material with a refractive index lower than the refractive index of the interlayer 3 are provided between the respective glass sheets 1, 2 and the interlayer 3, adjacent the interlayer 3. The refractive layers may be applied as a coating on each of the glass sheets 1; 2. In addition, the refractive layers may also be adhesive layers, thereby simplifying the manufacturing process. Preferably, the material of the interlayer 3 has been selected such that the refractive index of the interlayer is substantially the same as that of the glass sheets 1,2. Well-known materials for the interlayer are polyvinyl butyral (PVB) and ethylene-vinyl acetate (EVA), both materials having a refractive index of approximately 1.49, i.e. approximately the same as the refractive index of the glass sheet. To couple out the light from the light-guiding assembly, so-called scattering centers 20 are introduced into the light-guiding assembly for coupling out the light which is guided in the light-guiding assembly. Preferably, the scattering centers 20 are provided in between the interlayer 3 and the refractive layer 8. In the example of FIG. 2, the scattering centers 20 are provided at one side of the interlayer only, thereby confining the coupling-out of light to one direction only.

The refractive layers 8; 9 provide that the light has a preference for traveling in the interlayer and the coupling-out of light from the interlayer into the glass sheet is avoided. The refractive index of the material of the refractive layers 8; 9 is chosen such that no light traveling through the interlayer is coupled into the glass sheets. If the interlayer is made of PVB, the refractive index of the refractive layer is preferably lower than 1.42, resulting in a numerical aperture (N.A.) of 0.47. Suitable materials for such refractive layers are polymethyl methacrylate (PMMA; refractive index approximately 1.47), magnesium fluoride (MgF₂; refractive index approximately 1.38), and teflon (refractive index ≦1.35). When refractive layers of lower refractive index are provided between the interlayer and the glass sheets, the refractive index of the interlayer and the refractive index of the glass sheets are preferably approximately the same.

In the example of FIG. 2, the light-guiding assembly is provided with a recess 10. The recess 10 is adapted to receive the light-coupling means. Such a recess 10 provides that the majority of the light is coupled into the interlayer 3. When the coupling of light into the interlayer 3 made of PVB is performed with plastic fibers, which normally have a numerical aperture (N.A.) of approximately 0.47, the index of refraction of the refractive layers 8; 9 should preferably be:
N.A.=[(n_{interlayer})²−(n_{refractive layer})²)]^{1/2},
resulting in a refractive index of the refractive layer n_{layer}≦1.42. If the N.A. of the optical fibers is greater, a lower refractive index of the refractive layer is desirable.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A light-guiding assembly for vehicle roofs comprising:
a plurality of glass sheets (1, 2),
an interlayer (3) of a polymeric laminating material interposed between the glass sheets (1, 2),
light-coupling means (5) for coupling light into the light-guiding assembly,
the light coupled into the interlayer (3) being guided substantially through the interlayer (3).

2. A light-guiding assembly as claimed in claim 1, characterized in that the refractive index of the interlayer (3) is higher than the refractive index of the glass sheets (1, 2).

3. A light-guiding assembly as claimed in claim 2, characterized in that the refractive index of the interlayer (3) is higher than 1.57.

4. A light-guiding assembly as claimed in claim 1, characterized in that a refractive layer (8; 9) of a material with a refractive index lower than the refractive index of the interlayer (3) is provided between the glass sheets (1, 2) and the interlayer (3), adjacent the interlayer (3).

5. A light-guiding assembly as claimed in claim 4, characterized in that the refractive index of the refractive layer (8, 9) is lower than 1.50.

6. A light-guiding assembly as claimed in claim 4, characterized in that the refractive index of the interlayer (3) and the refractive index of the glass sheets (1, 2) are approximately the same.

7. A light-guiding assembly as claimed in claim 1, characterized in that the light-coupling means (5) are adapted to couple the majority of the light into the interlayer (3).

8. A light-guiding assembly as claimed in claim 1, characterized in that the light-guiding assembly is provided with a recess (10), the recess (10) being adapted to receive the light-coupling means (5).

9. A light-guiding assembly as claimed in claim 1, characterized in that one of the glass sheets is made of a light-absorbing material.

10. An automotive vehicle roof comprising a light-guiding assembly as claimed in claim 1.

11. An automotive vehicle roof as claimed in claim 9, characterized in that the vehicle roof is substantially translucent.
